(19) United States
(12) Patent Application Publication
(10) Pub. No.: US 2024/0020330 A1
(43) Pub. Date: Jan. 18, 2024

(54) SEARCHING AGAINST ATTRIBUTE VALUES OF DOCUMENTS THAT ARE EXPLICITLY SPECIFIED AS PART OF THE PROCESS OF PUBLISHING THE DOCUMENTS

(71) Applicant: Providence St. Joseph Health, Seattle, WA (US)

(72) Inventors: Lawrence Frederick Yapp, Auburn, WA (US); Janet Marie Vickers, Bothell, WA (US); Jennifer Grace Franks, Puyallup, WA (US)

(21) Appl. No.: 17/866,981

(22) Filed: Jul. 18, 2022

(51) Int. Cl. G06F 16/14; G06F 16/383; G06F 16/31; G06V 30/416

(52) U.S. Cl. CPC G06F 16/148; G06F 16/383; G06F 16/316; G06V 30/416

(57) ABSTRACT

A facility for indexing documents is described. The facility accesses a number of document manifests, each (a) corresponding to a different published document among a set of published documents, and (b) identifying, for each of a plurality of document attributes, a value of the attribute explicitly specified for the published document which the document manifest corresponds. The facility uses the accessed plurality of document manifests to construct a search index covering the set of published documents that is usable by a search engine to resolve queries each specifying a particular value for each of one or more of the plurality of document attributes.

### BACKGROUND

Search engines seek to identify documents among a set of documents that are the most relevant to a user-specified text string called a search query, or simply a query. While it is technically possible for search engines to compare each query to the entirety of the document set, in practice they generally apply each query to a search index compiled for the search engine by reading and analyzing the documents of the set. The contents of the documents of the set are often collected for representation in indices by programs associated with the search engine called “crawlers.”

Many of the techniques used to construct and apply search indices are tailored toward matching the documents of the set that literally contain words and multi-word phrases included in the query.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram showing the operation of the facility in some embodiments.

FIG. 3 is a flow diagram showing a process performed by the facility in some embodiments to publish a document that can be searched by the facility.

FIG. 4 is a display diagram showing a sample display presented by the facility in some embodiments that enables a user to construct a manifest for a document by entering values for some or all of the attributes established by the manifest template.

FIG. 5 is a flow diagram showing a process performed by the facility in some embodiments to process a query.

FIG. 6 is a display diagram showing a sample display presented by the facility in some embodiments to solicit a category-based query.

FIG. 7 is a display diagram showing a sample display presented by the facility in some embodiments in order to solicit a hierarchy-based query from a user.

FIG. 8 is a display diagram showing a sample display presented by the facility in some embodiments in order to elicit an attribute-based query from a user.

FIG. 9 is a display diagram showing a sample display presented by the facility in some embodiments in order to present a query result and provide for its exploration and exploitation by the searching user.

FIG. 10 is a display diagram showing a sample display presented by the facility in some embodiments to show additional information about a document in a query result when that document is selected.

### DETAILED DESCRIPTION

The inventors have recognized significant disadvantages in the operation of conventional search engines. First, while conventional indices are sometimes constructed to include document attributes automatically inferred from the content of documents, in practice such inference proves limited and frequently inaccurate. Accordingly, queries that seek to match documents having particular attributes are often unsuccessful. Additionally, even where a conventional search engine provides some limited ability to infer the values of certain document attributes, its querying user interface often lacks support that would enable users to explicitly specify a particular value for a particular attribute.

Also, in typical cases, documents can be added to a document set and included in search results—such as by publishing them anywhere on the Internet—without being subject to any level of quality control, leading to the undetected inclusion of inaccurate, outdated, redundant, unclear, and/or otherwise unhelpful documents in search results.

In response to recognizing these disadvantages, the inventors have conceived and reduced to practice a software and/or hardware facility for searching against attribute values of documents that are explicitly specified as part of the process of publishing the documents (“the facility”). In some embodiments, the facility enables an editor to specify a manifest template identifying different kinds of document attributes; the manifest template is populated by the publisher of each document with the document's values for these attributes, to create an attribute manifest specifying the document attribute values of the document, also called its metadata. Instead of or in addition to subjecting the literal contents of the documents of the set to the crawler, the crawler also consumes the attribute manifests. The facility uses the index produced from this crawling to service queries that explicitly specify certain values of certain document attributes. In some embodiments, in one or more ways, the facility is particularly adapted to documents that contain, reference, and/or completely embody structured or unstructured data sets, such as healthcare data sets. For example, in some embodiments, the facility's crawler is designed to digest and faithfully index the contents of such data sets. In some embodiments, the crawler follows links in a document's manifest or in the contents of the document to data sets and other information resources associated with the document to index those data sets and other information resources in connection with the document.

In various embodiments, the document attributes that are available for inclusion in the manifest template—and therefore available to specify values for in the manifests of individual documents—include title, description, author identity, author contact information, owner identity, owner contact information, publication date, effective date, category, hierarchy node, type of included or associated data, source of included or associated data, lineage of included or associated data showing the path this data has taken to the document, examples of included or associated data, links or pointers to included or associated data, associated application programming interfaces, information about access, copying, or other use of the document, etc.

In some embodiments, the facility enables the augmentation of a document's manifest with various additional information. For example, in some embodiments, the facility provides a “vouching” process for approving the content of a document. When a particular person vouches for a document, the facility adds to the document's manifest an indication of this vouching that identifies the vouching person. This vouching establishes trust in meritorious documents and data sets, and encourages the use both of (1) these document and datasets, and (2) a source of documents and datasets that explicitly surfaces this form of trust—i.e., the source operated by the facility.

In some embodiments, the facility provides a certification process for specifying a certification level for a document, such as by a human certifier or an automatic certification process. In some embodiments, each certification level specifies a subset of the attributes; if the manifest for a document contains values for all of the attributes in one of these subsets, an automatic process qualifies the document for the corresponding certification level. In some embodiments, the facility enables the fields specified for each certification level to be separately specified by and for each organization using the facility. Such a certification system incentivizes document publishers to more fully populate in a document's manifest values for the attributes most valuable to document searchers. This certification level, too, is added to the document's manifest. By making these kinds of validation information available via the search process, an organization can enable the use of high-quality information in its decision making processes.

In some embodiments, the facility makes available to query information added to documents' manifests via any supported mechanism or process. In some embodiments, the facility constructs a user interface for entering an attribute-specific query and exploring its results that is based on the contents of the manifest template. In some embodiments, the facility allows a user to filter or sort a search results using any information in the manifests of the documents included in a search result.

By operating in some or all of the ways described herein, the facility makes it possible for: an organization to specify document attributes that are available to describe and search for documents; a document's publisher to publish the document in customary ways, and explicitly describe it using values of the attributes specified by or for the organization; approvers and certifiers to weigh in on each document's level of quality, accuracy, helpfulness, currency, etc.; and/or a searching user to discover and explore documents whose attribute values match those specified by the searching user.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by enabling the explicit specifying of attribute values, the facility relieves the index-builder of the processing resource burden of performing inference to predict those attribute values. Also, by fulfilling queries that more acutely specify a querying user's intentions about certain document attributes, the facility avoids the processing resource burden of processing follow-up queries entered by querying users when initial queries fail to satisfy their needs. Also, by surfacing higher-quality documents that are more responsive to a query, the facility reduces the network resources needed to retrieve larger numbers of documents identified in a query result, only to discover that they are unhelpful.

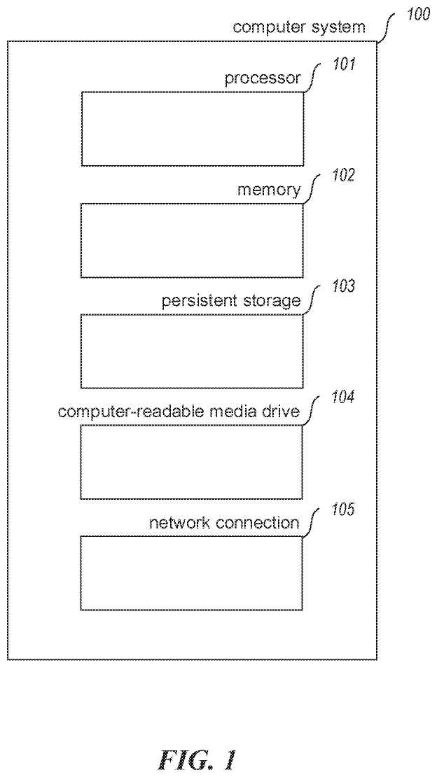

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

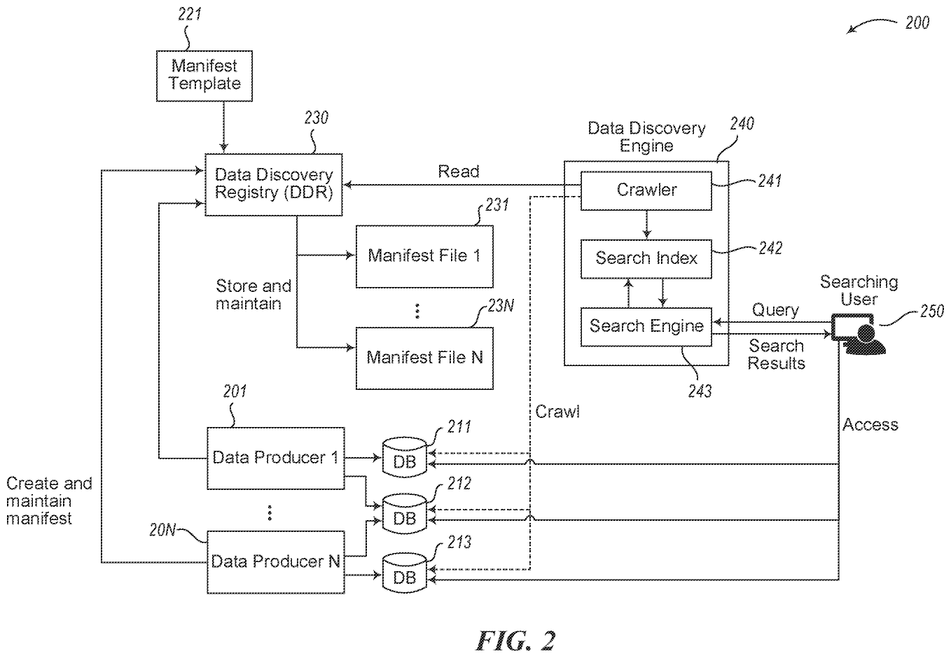

FIG. 2 is a data flow diagram showing the operation of the facility in some embodiments. In the data flow 200, a variety of authors or other data producers 201-20N generate for publication documents and data in repositories of various types, including databases and file systems. The process of publishing them involves two steps. The first is to store a copy of the document in one or more databases 211-213 or other repositories where they can be accessed by readers such as searching users. In various embodiments, these repositories are universally accessible via the Internet or another public network, or subject to access controls of a variety of types. The second part of publication is to generate a manifest for the document that the data producer submits to a data discovery registry 230, which in turn stores and maintains these manifest files 231-23N. In some embodiments, the data producers generate these manifest files by populating with document attribute values a manifest template 221 specifying a set of available document attributes. In some embodiments, the manifest template is generated on behalf of a group of data producers, such as those operating in a particular organization and/or subdivision of an organization, those working on particular subjects or types of data, etc. In some embodiments, the facility specifies information resources beyond the manifest template for a group of data producers, such as category list, topic hierarchy, and/or document certification and/or vouching criteria used by the facility.

In some embodiments, the facility uses the manifest template to generate a visual user interface that can be used by a data producer or their representative to enter values of the supported document attributes in order to create a manifest file for a particular document.

Either periodically or continuously, a crawler 241 incorporated in a data discovery engine 240—such as Apache Solr—reads the manifest files stored by the data discovery registry. In some embodiments, the crawler also reads the documents themselves in the document repository or repositories and/or data sets referenced by the manifests and/or the contained in or referenced by the documents stored in the repositories. From the information collected by this crawling, the data discovery engine generates and/or updates a search index 242 that associates the identity of different documents with data read about them by the crawler, including document contents, as well as document attributes read from the manifest. When a searching user submits a search query to a search engine 243 of the data discovery engine, it explicitly specifies values for one or more of the document attributes. The search engine applies the query against the search engine to generate a search result, which it returns to the searching user. The searching user can review the search results, and select documents from it to retrieve and/or view from the document repositories in which they are stored. Additional details about this process are provided below.

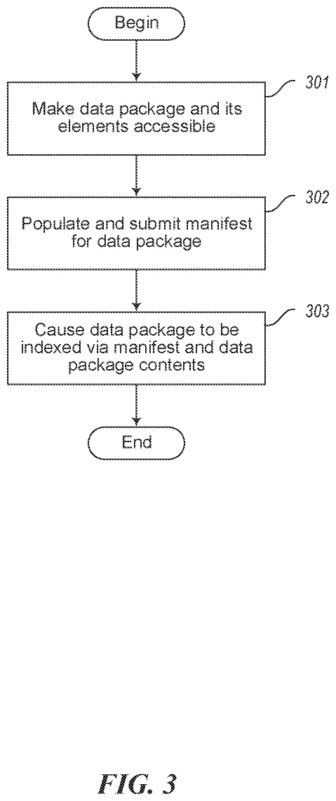

FIG. 3 is a flow diagram showing a process performed by the facility in some embodiments to publish a document that can be searched by the facility. In act 301, the facility makes a data package making up the document and its elements accessible for crawling, and for retrieval, such as by storing it in a document repository. In various embodiments, this data package includes one or more databases, diagrams, sample data, source-to-target mappings, release notes, links to external data and resources such as concepts, metadata, lineage, etc.

In act 302, the facility populates and submits a manifest for the data package. In some embodiments, the facility supports population of the document manifest in accordance with a document manifest template. In various embodiments, the manifest template is represented in different ways. As examples, the document manifest template may be a table that, for each included document attribute, specifies the attribute's name and data type or valid values; a document definition in a tag language such as XML or JSON; etc. Table 1 below shows a sample manifest template expressed in XML.

TABLE 1
Sample Manifest Template

| | |
|---|---|
| 1 | <template> |
| 2 | <field> |
| 3 | <title>Title</title> |
| 4 | <type>Text</type> |
| 5 | <required>Yes</required> |
| 6 | </field> |
| 7 | <field> |
| 8 | <title>Description</title> |
| 9 | <type>Text</type> |
| 10 | <required>Yes</required> |
| 11 | </field> |
| 12 | <field> |
| 13 | <title>Owner</title> |
| 14 | <type>Text</type> |
| 15 | <required>Yes</required> |
| 16 | </field> |
| 17 | <field> |
| 18 | <title>Contact</title> |
| 19 | <type>Text</type> |
| 20 | <required>Yes</required> |
| 21 | </field> |
| 22 | <field> |
| 23 | <title>Data Steward</title> |
| 24 | <type>Text</type> |
| 25 | <required>No</required> |
| 26 | </field> |
| 27 | <field> |
| 28 | <title>Request Access</title> |
| 29 | <type>Text</type> |
| 30 | <required>No</required> |
| 31 | </field> |
| 32 | <field> |
| 33 | <title>Type</title> |
| 34 | <type>Choice</type> |
| 35 | <choices> |
| 36 | <choice>STRUCTURED</choice> |
| 37 | <choice>SEMISTRUCTURED</choice> |
| 38 | <choice>UNSTRUCTURED</choice> |
| 39 | <choice>MIXED</choice> |
| 40 | </choices> |
| 41 | <required>Yes</required> |
| 42 | </field> |
| 43 | <field> |
| 44 | <title>Have Expiration</title> |
| 45 | <type>Boolean</type> |
| 46 | <iftrue> |
| 47 | <subfield> |
| 48 | <subtitle>Expire Date</subtitle> |
| 49 | <subtype>Date</subtype> |
| 50 | <subrequired>Yes</subrequired> |
| 51 | </subfield> |
| 52 | </iftrue> |
| 53 | <required>No</required> |
| 54 | </field> |
| 55 | <field> |
| 56 | <title>Sources</title> |
| 57 | <type>Text</type> |
| 58 | <required>Yes</required> |
| 59 | </field> |
| 60 | <field> |
| 61 | <title>Data Store</title> |
| 62 | <type>Link</type> |
| 63 | <required>Yes</required> |
| 64 | </field> |
| 65 | <field> |
| 66 | <title>Data Type</title> |
| 67 | <type>Text</type> |
| 68 | <required>No</required> |
| 69 | </field> |
| 70 | <field> |
| 71 | <title>Categories</title> |
| 72 | <type>Text</type> |
| 73 | <required>No</required> |
| 74 | </field> |
| 75 | <field> |
| 76 | <title>Hierarchy</title> |
| 77 | <type>Text</type> |
| 78 | <required>No</required> |
| 79 | </field> |
| 80 | <field> |
| 81 | <title>Data Lineage</title> |
| 82 | <type>Link</type> |
| 83 | <required>No</required> |
| 84 | </field> |
| 85 | <field> |
| 86 | <title>ER Diagrams</title> |
| 87 | <type>Link</type> |
| 88 | <required>No</required> |
| 89 | </field> |
| 90 | <field> |
| 91 | <title>Source to Target Mappings</title> |
| 92 | <type>Link</type> |
| 93 | <required>No</required> |
| 94 | </field> |
| 95 | <field> |
| 96 | <title>Samples</title> |
| 97 | <type>Link</type> |
| 98 | <required>No</required> |
| 99 | </field> |
| 100 | <field> |
| 101 | <title>Release Notes</title> |
| 102 | <type>Link</type> |
| 103 | <required>No</required> |
| 104 | </field> |
| 105 | <field> |
| 106 | <title>Certification</title> |
| 107 | <type>Choice</type> |
| 108 | <choices> |
| 109 | <choice>None</choice> |
| 110 | <choice>Bronze</choice> |
| 111 | <choice>Silver</choice> |
| 112 | <choice>Gold</choice> |
| 113 | </choices> |
| 114 | <required>No</required> |
| 115 | </field> |
| 116 | <field> |
| 117 | <title>Vouched By</title> |
| 118 | <type>Text</type> |
| 119 | <required>No</required> |
| 120 | </field> |
| 121 | </template> |

The template spans lines 1-121 of the table. The template defines its first attribute in lines 2-6, representing the document's title. In lines 3-5, the template specifies that the attribute's name is “TITLE,” its type is “TEXT,” and it is a required attribute—that is, each manifest must contain a value for it.

In lines 60-64, the manifest template defines a Data Store attribute whose value points to the storage location of the document/data package, which can be used by the crawler to (1) access the document/data package for indexing, and (2) refer to this document/data package in the index.

In various embodiments, the template can specify attributes of various types. One example is an attribute of a type called “Choice” called “Type” that is established in lines 32-42. In lines 36-39, the template specifies four different possible values of this document type attribute, from which one must be selected: “STRUCTURED,” “SEMISTRUCTURED,” “UNSTRUCTURED,” and “MIXED”.

In some embodiments, the template can specify that a particular document attribute—a “conditional attribute”—is to be used in a manifest only where a particular condition is satisfied. For example, in lines 43-54 the sample template specifies that an “Expire Date” attribute can be populated only if the value of a “Have Expiration” attribute is populated with the value true.

In some embodiments, the data producer uses the manifest template to generate a manifest for a new document and submits it programmatically to the data discovery registry, or causes it to be stored in a particular file system folder designated for the storage of manifests. In some embodiments, the facility uses the manifest template to generate a visual user interface designed to facilitate the population of a manifest for a new document by a user.

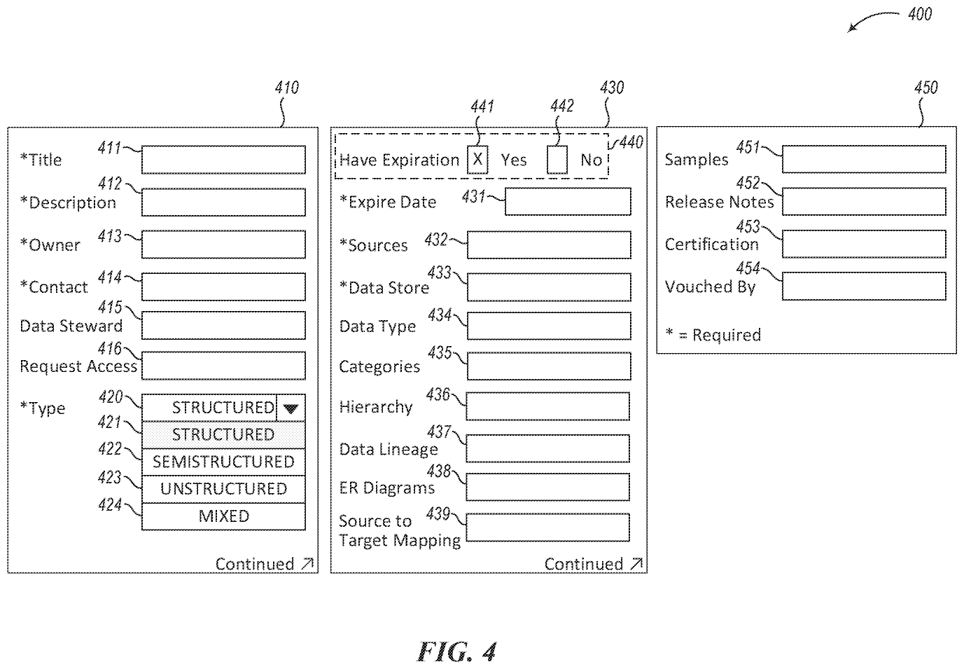

FIG. 4 is a display diagram showing a sample display presented by the facility in some embodiments that enables a user to construct a manifest for a document by entering values for some or all of the attributes established by the manifest template. The display 400 is made up of three panels 410, 430, 450, which in various embodiments are presented sequentially or simultaneously. Each of the panels contains fields or other user interface controls for entering values of attributes established by the manifest template. For example, the display includes a title field 411 for entering text constituting the document's title. An asterisk before the attribute name “Title” indicates that a value for this attribute is required. It can be seen by comparing the contents of the display to Table 1 above that the manifest template shown in Table 1 has been used to generate this user interface panel which reflects the attributes established by that manifest template. For example, the display shows a selection list control 420-424 that the user can use to select one of the four possible values for the Type attribute. Similarly, it can be seen that the “Expire Date” conditional attribute and field 431 for entering it have been displayed in response to the user selecting the value yes 441 for the “Have Expiration” document attribute 440. After populating values for the required attributes and any others that are desired, the user submits the form, such as by operating a user interface controls that is not shown.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

Table 2 below shows a sample document manifest. The manifest in Table 2 has been generated using the user interface shown in FIG. 4, and is predicated on the manifest template shown in Table 1.

TABLE 2
Sample Manifest

| | |
|---|---|
| 1 | *Title: Smoking and Lung Cancer |
| 2 | *Description: This is a dataset containing smoking and lung cancer |
| | information. There are 16 total tables from four different studies conducted |
| | over two years. Format is OMOP... |
| 3 | *Owner: James Smith |
| 4 | *Contact: james.smith@some.email.address |
| 5 | Data Steward: Healthcare Research Accelerator |
| 6 | Request Access: Data producer request form → Email |
| 7 | *Type: STRUCTURED |
| 8 | *Sources: Epic, Clarity, Meditech |
| 9 | *Data Store: DB1 database → links |
| 10 | Data Type: Curated |
| 11 | Categories: Cancer, Study, Outcomes |
| 12 | Hierarchy: Data > Cancer > Lung |
| 13 | Data Lineage: List here and → links |
| 14 | ER Diagrams: See → links |
| 15 | Source to Target Mappings: See → links |
| 16 | Samples: Data producer samples → links |
| 17 | Release Notes: Data producer's page → links |
| 18 | Certification: Gold |
| 19 | Vouched By: John Smith, VP of Research |
| 20 | ... |

Returning to FIG. 3, in act 303, the facility causes the data package to be indexed via the manifest, the contents of the data package, and the contents of any information resources linked to the manifest or the data package. After act 303, this process concludes.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

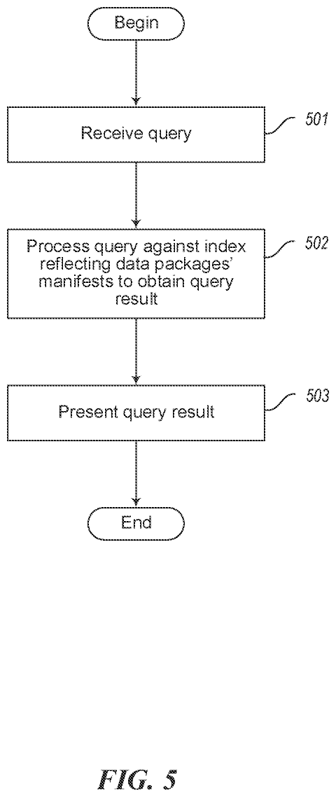

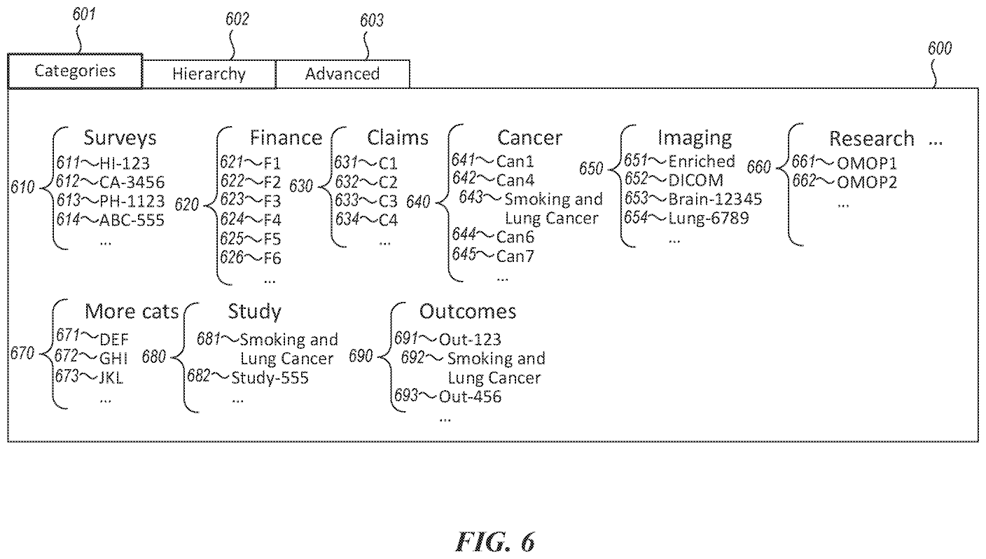

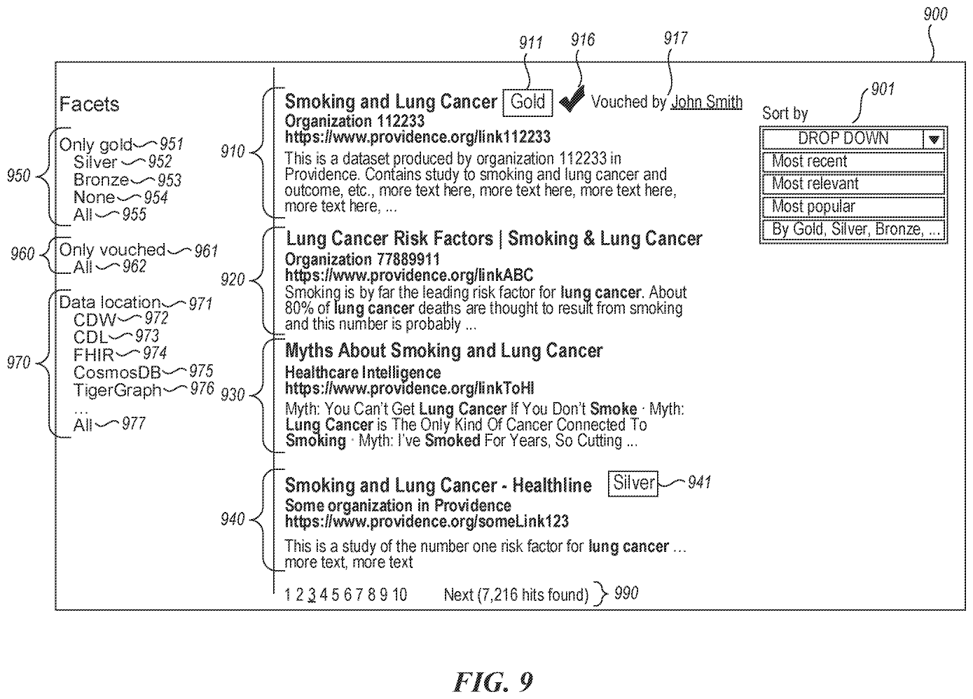

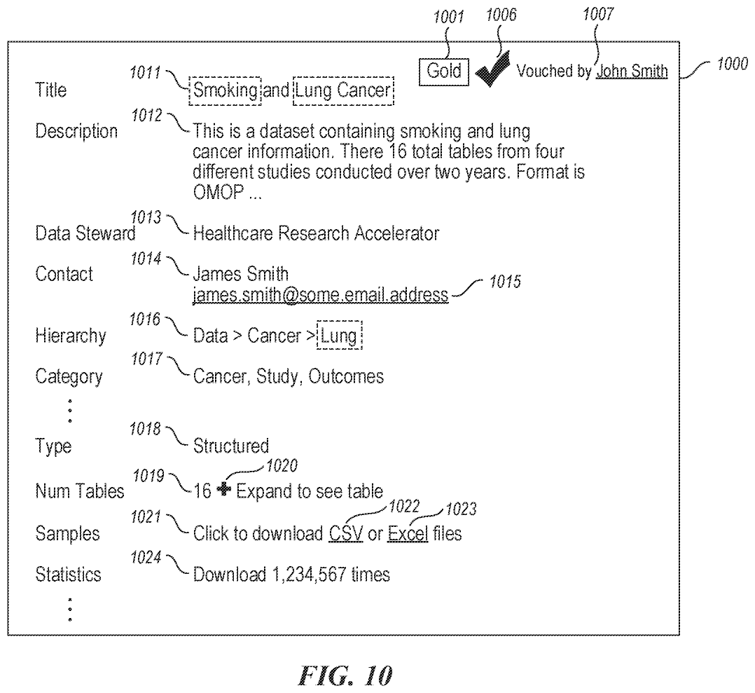

FIG. 5 is a flow diagram showing a process performed by the facility in some embodiments to process a query. In act 501, the facility receives a query. A variety of types of queries that may be received by the facility are shown in FIGS. 6-8 and discussed below. In act 502, the facility process the query received in act 501 against its search index—which reflects the contents of the manifests for the documents in the set—to obtain a query result. In act 503, the facility presents the query result obtained in act 502. FIGS. 9 and 10 show the presentation of a query result by the facility, and are described below. After act 503, this process concludes.

FIG. 6 is a display diagram showing a sample display presented by the facility in some embodiments to solicit a category-based query. The display 600 has three tabs 601-603, among which the user can select—such as by clicking on them—in order to select a query type. Here, it can be seen that the user selected the categories query type 601. As a result, the display contains visual indications of a number of different document categories, and their subcategories. For example, visual indication 680 shows the category “Study” and its subcategories “Smoking and Lung Cancer” 681 and “Study-555” 682. In some embodiments, this set of categories and subcategories are defined in the manifest template. In some embodiments, the facility reads the categories and subcategories from the manifest template as part of generating this display. The facility lists each document under one or more certain categories and subcategories based on these categories and subcategories being explicitly declared for the document in the document's manifest, either in reliance of these manifest contents being faithfully represented in the search index, or by reading the manifests or a secondary special-purpose index constructed to represent only these portions of the document manifests. The user can select any of these displayed categories or subcategories in order to submit a query for documents whose manifests specify the selected category or subcategory.

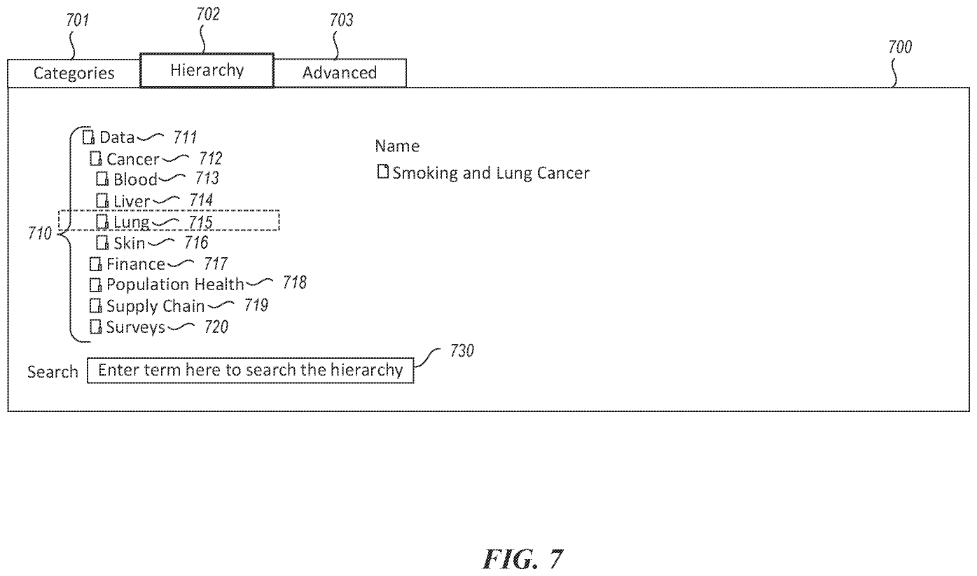

FIG. 7 is a display diagram showing a sample display presented by the facility in some embodiments in order to solicit a hierarchy-based query from a user. It can be seen in the display 700 that the “Hierarchy” tab 702 has been selected by the user. Accordingly, the facility has displayed a topic hierarchy 710 in which nodes such as nodes 711-720 each corresponding to a different topic, subtopic, sub-subtopic, etc., are shown in a hierarchical arrangement. For example, the Lung topic node 715 is a child node of the Cancer topic node 712, which is in turn a child node of a Data topic node 711. The user can select one of these topic nodes, such as by clicking on it, to submit a query for documents whose manifests specify that topic node. For example, the sample manifest contains the string “Data>Cancer>Lung” in its hierarchy attribute in line 12 of Table 2 to identify Lung topic node 715. In some embodiments, such a query also returns documents whose manifests specify topic nodes that are descendants of the selected topic node. In such embodiments, for example, documents whose manifests specify the Lung topic node would be included in a query result produced by the facility for a hierarchy-based query selecting the Cancer topic node. The display also includes a field 730 into which the user can enter a string in order to search for topic nodes containing that string.

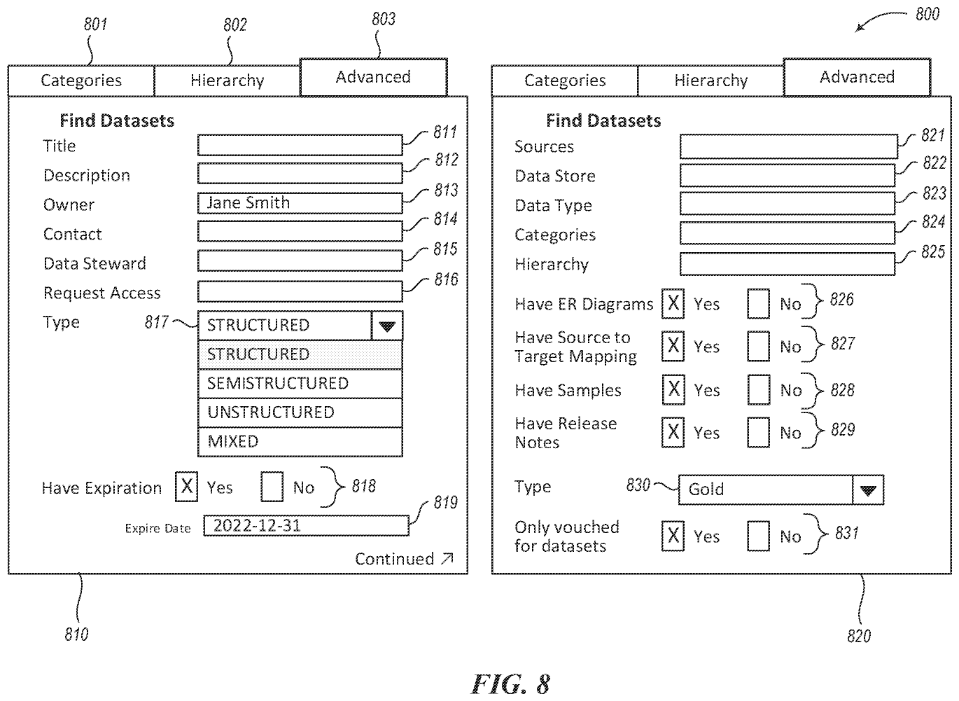

FIG. 8 is a display diagram showing a sample display presented by the facility in some embodiments in order to elicit an attribute-based query from a user. The display 800 is made up of panel 810 and 820, which can be sequentially or simultaneously displayed. It can be seen that the user has selected Advanced tab 803 in order to specify an attribute-based query. In some embodiments, the facility generates this display based upon the manifest template. Like the manifest population user interface shown in FIG. 4, the attribute-based query input user interface shown in FIG. 8 contains fields and controls corresponding to many of the document attributes established by the manifest template. The user can type values of these attributes, or otherwise operate user interface controls in order to specify them. For example, the user can type an owner or author name into field 813; select yes among the checkboxes 818 to query for documents having an expiration date, and type the desired expiration date into field 819. A variety of other attributes and attribute-based determinations are shown in the user interface for the user's use.

FIG. 9 is a display diagram showing a sample display presented by the facility in some embodiments in order to present a query result and provide for its exploration and exploitation by the searching user. The display 900 contains a number of visual indications 910, 920, 930, and 940 of documents that satisfy the query that has been input, such as via the user interfaces shown in FIGS. 6-8. Each of the visual indications contains information about the document, such as its title, author or organizational division, link, and description. In various embodiments, various portions of the visual indication are links that can be activated to retrieve and/or display the corresponding document. Where the document has a certification level, it is shown by a special visual insignia, such as insignias 911 and 941. Where a document is vouched for a particular person, the visual indication for the document in the query result contains a vouching icon 916, and a name 917 of the person who vouched for the document. In some embodiments, this name is a link that can be selected by the user to display information about or contact the vouching person. Legend 990 shows that this is one of several pages of search result contents; the user can click on a page number or use various other mechanisms to navigate to other pages of the query result. The user can reorder the query result by using a sorting control 901 to select a new basis for sorting the documents in the query result. Additionally, the user can filter the documents shown in the query result using controls on the left, such as controls 950 corresponding to different certification levels; controls 960 corresponding to whether documents are vouched for; and controls 970 corresponding to different locations or categorizations of the documents or associated data.

In some embodiments, selection of certain portions of the document's visual indication in the query result causes the display of a result card containing more extensive information about that document.

FIG. 10 is a display diagram showing a sample display presented by the facility in some embodiments to show additional information about a document in a query result when that document is selected. The display 1000 corresponds to the same document as visual indication 910 in the search results shown in FIG. 9. It contains information 1001 about the document's certification level, 1006-1007 about its vouching status, and other attribute values from 1011-1014 from the document's attributes. These can be explored and manipulated in various ways to access portions of the document, data sets referenced by or embedded in the document, etc.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system, comprising:
accessing a plurality of document manifests, each of the document manifests (a) compliant with a manifest template specified by a data producer, (b) corresponding to a different published document among a set of published documents, and (c) identifying, for each of a plurality of document attributes, a value of the attribute explicitly specified for the published document which the document manifest corresponds;
using the accessed plurality of document manifests to construct a search index covering the set of published documents,
resolving a query specifying a particular value for each of one or more of the plurality of document attributes using the constructed search index; and
persistently storing the constructed search index,
wherein a selected one of the plurality of document attributes for which a subset of the plurality of document manifests contain a value that is a reference to a dataset associated with the document to which the document manifest of the subset corresponds,
the method further comprising:
for each of the document manifests of the subset:
causing the dataset referenced by the document manifest's value for the selected document attribute to be crawled to obtain crawling results,
and wherein the obtained crawling results are also used in constructing the search index.

2. The method of claim 1, further comprising:
receiving a query specifying a particular value for each of one or more of the plurality of document attributes; and
applying the received query against the constructed search index to generate a query result identifying published documents of the set satisfying the received query.

3. (canceled)

4. The method of claim 1, further comprising:
receiving an indication that an identified person has vouched for the reliability of a selected published document of the set,
wherein the indication is also used in constructing the search index.

5. The method of claim 1, further comprising:
receiving automatic certification results for a selected published document of the set reflecting, for each of one or more different certification levels, whether the document manifest of the selected published document populates a subset of the document attributes defined in the manifest template that are specified for the certification level,
wherein the automatic certification results are also used in constructing the search index.

6. The method of claim 1, further comprising:
for each of the plurality of document manifests,
receiving the document manifest in connection with publication of the published document to which the document manifest corresponds; and
persistently storing the received document manifest in a document manifest repository.

7. A method in a computing system, comprising:
accessing a document manifest template specified by a data producer comprising a plurality of first entries, wherein each first entry corresponds to a different one of a plurality of document attributes and includes:
first information specifying a name of the document attribute;
second information specifying valid values of the document attribute;
using the document manifest template to generate a first user interface for collecting document manifest values of some or all of a plurality of document attributes for a first document as a basis for constructing a document manifest for the first document;
presenting the first user interface to a first user;
receiving, by the first user interface, document manifest values of some or all of the plurality of document attributes for a first document in a set of documents as a basis for constructing a document manifest for the first document;
storing the received document manifest values as a document manifest for the first document;
generating, from the plurality of first entries, a second user interface for collecting search values of some or all of the plurality of document attributes as a basis for constructing a search query for documents whose document manifests contain the collective values;
presenting the second user interface to a second user; and
receiving, by the second user interface, search values for some or all of the plurality of document attributes as a basis for constructing a search query for documents whose document manifests contain the search values.

8. The method of claim 7 wherein the plurality of document attributes comprise one or more document attributes selected from among:
title;
description;
author identity;
author contact information;
owner identity;
owner contact information;
publication date;
effective date;
category;
hierarchy node;
type of included or associated data;
source of included or associated data;
lineage of included or associated data;
example of included or associated data;
reference to included or associated data; and
associated application programming interface.

9. (canceled)

10. (canceled)

11. (canceled)

12. One or more instances of computer-readable media not constituting signals per se, the one or more instances of computer-readable media collectively having contents configured to cause a computing system to perform a method, the method comprising:
receiving a document search query that specifies values of one or more document attributes among a plurality of document attributes specified by a document manifest template wherein the document manifest template is compliant with a document manifest template specified by a data producer; and
applying the received query to a search index covering a set of documents to identify documents of the set for each of which a document manifest has been submitted that indicates that the identified document has the values specified by the received query for the corresponding document attributes, wherein at least one of the submitted document manifests contains a value that is a reference to a dataset associated with the document to which the document manifest corresponds, and the dataset referenced has been crawled to obtain crawling results, and wherein the obtained crawling results are used in constructing the search index.

13. The one or more instances of computer-readable media of claim 12, the method further comprising:
causing to be presented a query entry user interface comprising, for each of the plurality of document attributes specified by the document manifest template, a user interface control operable by user input to specify a value of the document attribute, and wherein receiving the query comprises receiving user input operating user interface controls among the presented user interface controls to specify the values specified by the received query.

14. The one or more instances of computer-readable media of claim 12, the method further comprising:
causing at least a portion of a query result conveying the identified documents of the set to be visually presented.

15. The one or more instances of computer-readable media of claim 14 wherein the visual presentation includes, for a distinguished one of the identified documents, a visual indication that the document has been either vouched for by an identified person or has been certified at an identified level.

16. The one or more instances of computer-readable media of claim 14, the method further comprising:
causing display of visual indications of a subset of the plurality of document attributes;
receiving user input selecting one of the visual indications; and
in response to the receiving, causing at least a portion of the query result to be re-displayed with the identified documents in an order reflecting the values of the document attribute whose visual indication was selected specified by the identified documents' document manifests.

17. The one or more instances of computer-readable media of claim 14, the method further comprising:
causing display of visual indications of, for a distinguished document attribute, two or more ranges each of one or more valid values of the distinguished document attribute;
receiving user input selecting one of the visual indications; and
in response to the receiving, causing at least a portion of the query result to be re-displayed omitting any identified documents whose document manifests do not specify for the distinguished document attribute a value in the range of the visual indication that was selected.

18. The one or more instances of computer-readable media of claim 14 wherein a selected one of the plurality of document attributes for which some or all of the plurality of document manifests contain a value that is a document category among a plurality of document categories to which the document to which the document manifest corresponds belongs,
the method further comprising:
causing display of visual indications of at least a portion of the plurality of document categories;
receiving user input selecting one of the visual indications; and
in response to the receiving, causing at least a portion of the query result to be re-displayed omitting any identified documents whose document manifests do not specify for the selected document attribute a value matching the document category whose visual indication was selected.

19. The one or more instances of computer-readable media of claim 14 wherein a selected one of the plurality of document attributes for which some or all of the plurality of document manifests contain a value that is a document hierarchy node among a plurality of document hierarchy nodes making up a document hierarchy tree to which the document to which the document manifest corresponds belongs,
the method further comprising:
causing display of a visual representation of at least a portion of the document hierarchy tree;
receiving user input selecting one of the document hierarchy nodes shown in the visual representation; and
in response to the receiving, causing at least a portion of the query result to be re-displayed omitting any identified documents whose document manifests do not specify for the selected document attribute a value matching the document hierarchy node that was selected.
